(19) United States
(12) Patent Application Publication
(10) Pub. No.: US 2004/0219367 A1
(43) Pub. Date: Nov. 4, 2004

(54) Low-temperature-curable, solid polyurethane powder coating compositions containing uretdione groups

(75) Inventors: Emmanouil Spyrou, Dorsten (DE); Holger Loesch, Herne (DE); Andreas Wenning, Nottuln (DE); Joern Volker Weiss, Haltern am See (DE); Werner Grenda, Herne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/836,540

(22) Filed: May 3, 2004

(30) Foreign Application Priority Data
May 3, 2003 (DE) 103 20 267.6

(51) Int. Cl. C08G 18/81; B32B 27/00; B32B 27/40

(52) U.S. Cl. 428/423.1; 525/452

(57) ABSTRACT

Solid polyurethane powder compositions which contain uretdione groups and cure at low baking temperatures, to processes for preparing such compositions, and to their use for producing plastics, especially powder coatings, which crosslink to high-gloss or matt, light- and weather-stable coating films.

### BACKGROUND OF THE INVENTION

1. Field of the Invention

The present invention relates to a solid polyurethane powder coating composition which contains a uretdione group and cures at low baking temperatures, to a process for preparing such composition, and to its use for producing plastics.

2. Discussion of the Background

Externally or internally blocked polyisocyanates which are solid at room temperature constitute valuable crosslinkers for thermally crosslinkable polyurethane (PU) powder coating compositions.

For example, DE-A 27 35 497 describes PU powder coatings featuring outstanding weathering stability and thermal stability. The crosslinkers whose preparation is described in DE-A 27 12 931 are composed of isophorone diisocyanate which contains isocyanurate groups and is blocked with ε-caprolactam. Also known are polyisocyanates which contain urethane, biuret or urea groups and whose isocyanate groups are likewise blocked.

The disadvantage of these externally blocked systems lies in the elimination of the blocking agent during the thermal crosslinking reaction. Since the blocking agent may thus be emitted into the environment, it is necessary on environmental and occupational hygiene grounds to take special measures to clean the outgoing air and/or to recover the blocking agent. Moreover, the reactivity of the crosslinkers is low. Curing temperatures above 170° C. are required.

DE-A 3030539 and DE-A 3030572 describe processes for preparing polyaddition compounds which contain uretdione groups and whose terminal isocyanate groups are irreversibly blocked with monoalcohols or monoamines. A particular disadvantage are the chain-terminating constituents of the crosslinkers, which lead to low network densities in the PU powder coatings and thus to moderate solvent resistances.

Hydroxyl-terminated polyaddition compounds containing uretdione groups are subject matter of EP 0 669 353. On the basis of their functionality of two they exhibit improved resistance to solvents. A common feature of the powder coating compositions based on these polyisocyanates containing uretdione groups is that they do not emit any volatile compounds in the course of the curing reaction. However, at at least 180° C., the baking temperatures are high.

The use of amidines as catalysts in PU powder coating compositions is described in EP 803 524. Although these catalysts lead to a reduction in the curing temperature, they exhibit a marked yellowing, which is generally unwanted in the coatings field. The cause of this yellowing is probably the reactive nitrogen atoms in the amidines. These can react with atmospheric oxygen to give N-oxides, which are responsible for the discoloration.

EP 803 524 also mentions other catalysts which have been used to date for this purpose, but without showing any particular effect on the curing temperature. They include the organometallic catalysts known from polyurethane chemistry, such as dibutyltin dilaurate (DBTL), for example, or else tertiary amines, such as 1,4-diazabicyclo[2.2.2]octane (DABCO), for example.

WO 00/34355 claims catalysts based on metal acetylacetonates, e.g., zinc acetylacetonate. Such catalysts are in fact able to lower the curing temperature of polyurethane powder coating compositions containing uretdione groups, but as reaction products give primarily allophanates (M. Gedan-Smolka, F. Lehmann, D. Lehmann, “New catalysts for the low temperature curing of uretdione powder coatings” International Waterborne, High solids and Powder Coatings Symposium, New Orleans, Feb. 21-23, 2001). Allophanates are the reaction products of one mole of alcohol and two moles of isocyanate, whereas in the conventional urethane chemistry one mole of alcohol reacts with one mole of isocyanate. Therefore, as the result of the unwanted formation of allophanates, isocyanate groups valuable both technically and economically are destroyed.

### SUMMARY OF THE INVENTION

It is an object of the present invention to provide highly reactive polyurethane powder coating compositions containing uretdione groups which can be cured even at very low temperatures and which are particularly suitable for producing plastics and also for producing high-gloss or matt, light- and weather-stable powder coatings.

This and other objects have been achieved by the present invention the first embodiment of which includes a highly reactive polyurethane powder coating composition, comprising:

A) at least one uretdione-containing powder coating hardener based on aliphatic, (cyclo)aliphatic or cycloaliphatic polyisocyanates and hydroxyl-containing compounds, the hardener having a melting point of from 40 to 130° C., a free NCO content of less than 5% by weight, and a uretdione content of 6-18% by weight,

B) at least one hydroxyl-containing polymer having a melting point of from 40 to 130° C., and an OH number of between 20 and 200 mg KOH/g,

C) at least one catalyst of the formula

M(OR¹)ₙ(OR²)ₘ(OR)ₒ(OR⁴)ₚ(OR⁵)_{q}(OR⁶)ᵣ,

wherein

M is a metal in any positive oxidation state which is identical with the sum n+m+o+p+q+r,

m, o, p, q and r are integers 0 to 6,

the sum n+m+o+p+q+r=1 to 6,

the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms,

wherein components A) and B) are present in a ratio so that for each hydroxyl group of component B) there is from 0.3 to 1 uretdione group of component A), and

wherein a fraction of the catalyst under C) is 0.001-3% by weight, based on a total amount of components A) and B).

In another embodiment, the present invention relates to a process for preparing a highly reactive polyurethane powder coating composition, comprising

admixing the following components A), B) and C) in a heatable mixer at a temperature of not more than 130° C.;

wherein

A) at least one uretdione-containing powder coating hardener based on aliphatic, (cyclo)aliphatic or cycloaliphatic polyisocyanates and hydroxyl-containing compounds, the hardener having a melting point of from 40 to 130° C., a free NCO content of less than 5% by weight, and a uretdione content of 6-18% by weight,

B) at least one hydroxyl-containing polymer having a melting point of from 40 to 130° C., and an OH number of between 20 and 200 mg KOH/g,

C) at least one catalyst of the formula

M(OR¹)ₙ(OR²)ₘ(OR³)ₒ(OR⁴)ₚ(OR⁵)_{q}(OR⁶)ᵣ,

wherein

M is a metal in any positive oxidation state which is identical with the sum n+m+o+p+q+r,

m, o, p, q and r are integers 0 to 6,

the sum n+m+o+p+q+r=1 to 6,

the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms,

wherein components A) and B) are present in a ratio so that for each hydroxyl group of component B) there is from 0.3 to 1 uretdione group of component A), and

wherein a fraction of the catalyst under C) is 0.001-3% by weight based on a total amount of components A) and B).

In yet another embodiment, the present invention relates to a method of curing a powder coating composition, comprising:

curing the above powder coating composition at a temperature of not more than 160° C.

In another embodiment, the present invention relates to a catalyst, comprising:

a compound of the formula

M(OR¹)ₙ(OR²)ₘ(OR³)ₒ(OR⁴)ₚ(OR⁵)_{q}(OR⁶)ᵣ,

wherein

M is a metal in any positive oxidation state which is identical with the sum n+m+o+p+q+r,

m, o, p, q and r are integers 0 to 6,

the sum n+m+o+p+q+r=1 to 6,

the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms.

The present invention also relates to methods of coating substrates and to coated substrates.

### DETAILED DESCRIPTION OF THE INVENTION

It has surprisingly been found that metal hydroxides and alkoxides accelerate the cleavage of uretdione groups so greatly that when using uretdione-containing powder coating hardeners it is possible to reduce considerably the curing temperature of powder coating compositions.

The present invention provides a highly reactive polyurethane powder coating composition comprising

A) at least one uretdione-containing powder coating hardener based on aliphatic, (cyclo)aliphatic or cycloaliphatic polyisocyanates and hydroxyl-containing compounds, the hardener having a melting point of from 40 to 130° C., a free NCO content of less than 5% by weight, and a uretdione content of 6-18% by weight,

B) at least one hydroxyl-containing polymer having a melting point of from 40 to 130° C., and an OH number of between 20 and 200 mg KOH/g,

C) at least one catalyst of the formula

M(OR¹)ₙ(OR²)ₘ(OR³)ₒ(OR⁴)ₚ(OR⁵)_{q}(OR⁶)ᵣ,

in which M is a metal in any positive oxidation state which is identical with the sum n+m+o+p+q+r,

m, o, p, q and r are integers 0-6 and the sum n+m+o+p+q+r=1, to 6, the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms,

D) optionally, a reactive compound which is able to react at elevated temperatures with any acid groups that may be present in component B),

E) optionally, auxiliaries and additives known from powder coating chemistry,

such that the two components A) and B) are present in a ratio such that for each hydroxyl group of component B) there is from 0.3 to 1 uretdione group of component A), the fraction of the catalyst under C) is 0.001-3% by weight of the total amount of components A) and B), and D) is present where appropriate in a proportion by weight, based on the total formulation, of 0.1 to 10%.

The melting point of the uretdione-containing powder coating hardener includes all values and subvalues therebetween, especially including 50, 60, 70, 80, 90, 100, 110 and 120° C. The free NCO content of the uretdione-containing powder coating hardener includes all values and subvalues between 0 and less than 5% by weight, especially including 0.5, 1, 1.5, 2, 2.5, 3, 3.5, 4 and 4.5% by weight. The uretdione content of the uretdione-containing powder coating hardener includes all values and subvalues therebetween, especially including 8, 10, 12, 14 and 16% by weight. The melting point of the hydroxyl-containing polymer includes all values and subvalues therebetween, especially including 50, 60, 70, 80, 90, 100, 110 and 120° C. The OH number of the hydroxyl-containing polymer includes all values and subvalues therebetween, especially including 30, 40, 50, 60, 70, 80, 90, 100, 110, 120, 130, 140, 150, 160, 170, 180 and 190 mgKOH/g. The amount of uretdione group for each hydroxyl group includes all values and subvalues therebetween, especially including 0.4, 0.5, 0.6, 0.7, 0.8 and 0.9. The amount of the catalyst C) includes all values and subvalues therebetween, especially including 0.005, 0.01, 0.05, 0.1, 0.5, 1, 1.5, 2 and 2.5% by weight.

The amount of D) includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5% by weight.

The present invention further provides a process for preparing the powder coating composition.

The present invention additionally provides for the use of the powder coating compositions of the present invention for producing powder coatings on metal, plastics, glass, wood or leather substrates or other heat-resistant substrates.

The present invention additionally provides metal coating compositions, especially for automobile bodies, motorbikes and bicycles, construction components, and household appliances, wood coating compositions, glass coating compositions, leather coating compositions, and plastics coating compositions comprising a polyurethane powder coating composition comprising

A) at least one uretdione-containing powder coating hardener based on aliphatic, (cyclo)aliphatic or cycloaliphatic polyisocyanates and hydroxyl-containing compounds, the hardener having a melting point of from 40 to 130° C., a free NCO content of less than 5% by weight, and a uretdione content of 6-18% by weight,

B) at least one hydroxyl-containing polymer having a melting point of from 40 to 130° C., and an OH number of between 20 and 200 mg KOH/g,

C) at least one catalyst of the formula

M(OR¹)ₙ(OR²)ₘ(OR³)ₒ(OR⁴)ₚ(OR⁵)_{q}(OR⁶)ᵣ,

in which M is a metal in any positive oxidation state which is identical with the sum n+m+o+p+q+r,

m, o, p, q and r are integers 0-6 and the sum n+m+o+p+q+r=1 to 6,

the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms,

such that the two components A) and B) are present in a ratio such that for each hydroxyl group of component B) there is from 0.3 to 1 uretdione group of component A), and the fraction of the catalyst under C) is 0.001-3% by weight of the total amount of components A) and B).

The melting point of the uretdione-containing powder coating hardener includes all values and subvalues therebetween, especially including 50, 60, 70, 80, 90, 100, 110 and 120° C. The free NCO content of the uretdione-containing powder coating hardener includes all values and subvalues between 0 and less than 5% by weight, especially including 0.5, 1, 1.5, 2, 2.5, 3, 3.5, 4 and 4.5% by weight. The uretdione content of the uretdione-containing powder coating hardener includes all values and subvalues therebetween, especially including 8, 10, 12, 14 and 16% by weight. The melting point of the hydroxyl-containing polymer includes all values and subvalues therebetween, especially including 50, 60, 70, 80, 90, 100, 110 and 120° C. The OH number of the hydroxyl-containing polymer includes all values and subvalues therebetween, especially including 30, 40, 50, 60, 70, 80, 90, 100, 110, 120, 130, 140, 150, 160, 170, 180 and 190 mgKOH/g. The amount of uretdione group for each hydroxyl group includes all values and subvalues therebetween, especially including 0.4, 0.5, 0.6, 0.7, 0.8 and 0.9. The amount of the catalyst C) includes all values and subvalues therebetween, especially including 0.005, 0.01, 0.05, 0.1, 0.5, 1, 1.5, 2 and 2.5% by weight.

Polyisocyanates containing uretdione groups are well known and are described, for example, in U.S. Pat. No. 4,476,054, U.S. Pat. No. 4,912,210, U.S. Pat. No. 4,929,724 and EP 417 603. A comprehensive overview of industrially relevant processes for dimerizing isocyanates to give uretdiones is given by J. Prakt. Chem. 336 (1994) 185-200. In general, isocyanates are reacted to uretdiones in the presence of soluble dimerization catalysts such as, for example, dialkylaminopyridines, trialkylphosphines, phosphorous triamides or imidazoles. The reaction—conducted optionally in solvents but preferably in their absence—is terminated by adding catalyst poisons when a desired conversion has been reached. Excess monomeric isocyanate is subsequently separated off by short-path evaporation. If the catalyst is volatile enough, the reaction mixture can be freed from the catalyst in the course of the separation of monomer. In this case there is no need to add catalyst poisons. In principle, a broad palette of isocyanates is suitable for the preparation of polyisocyanates containing uretdione groups. In accordance with the present invention, isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), and tetramethylxylylene diisocyanate (TMXDI) are used with preference. Very particular preference is given to IPDI and HDI.

The reaction of these polyisocyanates carrying uretdione groups to give powder coating hardeners A) containing uretdione groups includes the reaction of the free NCO groups with hydroxyl-containing monomers or polymers, such as polyesters, polythioethers, polyethers, polycaprolactams, polyepoxides, polyester-amides, polyurethanes or low molecular mass di-, tri- and/or tetraalcohols as chain extenders and, optionally, monoamines and/or monoalcohols as chain terminators and has already been described on many occasions (EP 669 353, EP 669 354, DE 30 30 572, EP 639 598 or EP 803 524). Preferred powder coating hardeners A) containing uretdione groups have a free NCO content of less than 5% by weight and a uretdione group content of from 6 to 18% by weight (calculated as C₂N₂O₂, molecular weight 84). Polyesters and monomeric dialcohols are preferred. Preferred low-molecular diols are ethyleneglycol, propanediol-(1,2); propanediol-(1,3); 2,2-dimethylpropane-(1,3), butandiol-(1,4), hexanediol-(1,6), 2-methylpentanediol-(1,5), 2,2,4-trimethylhexanediol-(1,6), 2,4,4-trimethylhexanediol-(1,6), heptanediol (1,7), dodecanediol-(1,12), octa-decene-9,10-diol-(1,12), thioglycol, octandecanediol-(1,18), 2,4-dimethyl-2-propylheptane-diol-(1,3), diethyleneglycol, triethyleneglycol, tetraethyleneglycol, trans- and cis-1,4-cyclohexane-dimethanol. Preferred low-molecular triols are glycerin, hexanetriol-(1,2,6), 1,1,1-trimethylol-propane and trimethylol-ethane. A preferred low-molecular tetraol is pentarythrit. Besides the uretdione groups, the powder coating hardeners may also contain isocyanurate, biuret, allophanate, urethane and/or urea structures.

In the case of the hydroxyl-containing polymers B), preference is given to the use of polyesters, polyethers, polyacrylates, polyurethanes and/or polycarbonates having an OH number of 20-200 (in mg KOH/g). Particular preference is given to using polyesters having an OH number of 30-150, an average molecular weight of 500-6000 g/mol, and a melting point of between 40 and 130° C. Binders of this kind have been described, for example, in EP 669 354 and EP 254 152. It is of course also possible to use mixtures of such polymers. The amount of the hydroxyl-containing polymers B) is chosen such that for each hydroxyl group of component B) there is from 0.3 to 1 uretdione group of component A).

The present invention also provides for the use of at least one catalyst of the formula M(OR¹)ₙ(OR²)ₘ(OR³)ₒ(OR⁴)ₚ(OR⁵)_{q}(OR⁶)ᵣ, in which M is a metal in any positive oxidation state which is identical with the sum n+m+o+p+q+r, m, o, p, q and r are integers 0-6 and the sum n+m+o+p+q+r=1 to 6, the radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms, in polyurethane powder coating compositions, and also the catalysts themselves.

The catalysts C) of the present invention satisfy the formula M(OR¹)ₙ(OR²)ₘ(OR³)ₒ(OR⁴)ₚ(OR⁵)_{q}(OR⁶)ᵣ, in which M is a metal in any positive oxidation state which is identical with the sum n+m+o+p+q+r, m, o, p, q and r are integers 0-6 and the sum n+m+o+p+q+r=1 to 6. The radicals R¹-R⁶ simultaneously or independently of one another are hydrogen or alkyl, aryl, aralkyl, heteroaryl or alkoxyalkyl radicals having 1-8 carbon atoms and the radicals are in each case linear or branched, unbridged or bridged with other radicals, to form monocyclic, bicyclic or tricyclic ring systems and the bridging atoms beside carbon may also be heteroatoms and may additionally have one or more alcohol, amino, ester, keto, thio, urethane, urea or allophanate groups, double bonds, triple bonds or halogen atoms. Examples of such catalysts are lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide and barium phenoxide. Mixtures of such catalysts may also be used, of course. They are present in the powder coating composition in an amount of 0.001-3% by weight, preferably 0.01-3% by weight, based on components A) and B). The catalysts may contain water of crystallization, which is not taken into account when calculating the amount of catalyst employed; that is, the amount of water is neglected during the calculation. Particular preference is given to using barium hydroxide and lithium isopropoxide.

One preferred embodiment of the present invention comprises the polymeric attachment of such catalysts C) to powder coating hardeners A) or hydroxyl-containing polymers B). Thus it is possible, for example, to react free alcohol, thio or amino groups of the ammonium salts with acid, isocyanate or glycidyl groups of the powder coating hardeners A) or hydroxyl-containing polymers B), in order to integrate the catalysts C) into the polymeric system.

In this context it must be borne in mind that the activity of these catalysts decreases sharply in the presence of acids. The conventional co-reactants of the uretdione-containing powder coating hardeners include hydroxyl-containing polyesters. Because of the way in which polyesters are prepared, they occasionally still carry acid groups to a minor extent. The amount of acid groups in the polyesters should be less than 20 mg KOH/g, since otherwise the catalysts are excessively inhibited. The amount of acid groups in the polyesters includes all values and subvalues between more than 0 and 20 mg, especially including 2, 4, 6, 8, 10, 12, 14, 16 and 18 mg. In the presence of polyesters of this kind which carry acid groups, therefore, it is appropriate either to use the aforementioned catalysts in excess over the acid groups or else to add reactive compounds which are able to scavenge acid groups. Both monofunctional and polyfunctional compounds can be used for this purpose. The possibly crosslinking effect of the polyfunctional compounds, although unwanted owing to the viscosity-increasing effect, is generally not disruptive owing to the low concentration.

Reactive, acid-scavenging compounds D) are common knowledge in coatings chemistry. For example, epoxy compounds, carbodiimides, hydroxyalkylamides or else 2-oxazolines react with acid groups at elevated temperatures. Suitable examples include Versatic acid glycidyl ester, ethylhexyl glycidyl ether, butyl glycidyl ether, POLYPOX R 16 (pentaerythritol tetraglycidyl ether, produced by UPPC AG), triglycidyl ether isocyanurate (TGIC), EPIKOTE® 828 (diglycidyl ether based on bisphenol A, produced by Shell), and also VESTAGON EP HA 320 (hydroxyalkylamide, produced by Degussa AG), phenylenebisoxazoline, 2-methyl-2-oxazoline, 2-hydroxyethyl-2-oxazoline, 2-hydroxypropyl-2-oxazoline, and 5-hydroxypentyl-2-oxazoline. Mixtures of such substances are of course also suitable. The reactive compound D) is only employed when acid groups are present in the powder coating composition. Where such acid groups are present in the powder coating composition, the reactive component D) is added in a proportion by weight, based on the total formulation, of 0.1 to 10%, preferably 0.5 to 3%. The amount of D) includes all values and subvalues therebetween, especially including 0, 5, 1, 1.5, 2, 2.5, 3, 3.5, 4, 4.5, 5, 5.5, 6, 6.5, 7, 7.5, 8, 8.5, 9, and 9.5% by weight. It is also possible to use catalysts which accelerate this reaction between acid groups and acid scavengers, such as benzyltrimethylammonium chloride, for example.

For the preparation of powder coating materials it is possible to add the additives E) customary in powder coating technology, such as leveling agents, e.g., polysilicones or acrylates, light stabilizers, e.g., sterically hindered amines, or other auxiliaries, as described, for example, in EP 669 353, in a total amount of from 0.05 to 5% by weight. Fillers and pigments such as titanium dioxide, for example, can be added in an amount of up to 50% by weight of the total composition. The amount of E) includes all values and subvalues therebetween, especially including 0.1, 0.5, 1, 1.5, 2, 2.5, 3, 3.5, 4 and 4.5% by weight. The amount of filler and pigments includes all values and subvalues between 0 and 50% by weight, especially including 5, 10, 15, 20, 25, 30, 35, 40 and 45% by weight.

Additional catalysts, such as are already known in polyurethane chemistry, may optionally be present. These are primarily organometallic catalysts, such as dibutyltin dilaurate, or else tertiary amines, such as 1,4-diazabicyclo[2.2.2]octane, in amounts of 0.001-1% by weight. The amount of additional catalysts includes all values and subvalues therebetween, especially including 0.005, 0.01, 0.05, 0.1, 0.2, 0.3, 0.4, 0.5, 0.6, 0.7, 0.8 and 0.9% by weight.

Conventional uretdione-containing powder coating compositions can be cured only above 180° C. under normal conditions (DBTL catalysis). With the aid of the low-temperature-curing powder coating compositions of the present invention, with cure temperatures of a maximum of 160° C. (lower cure temperatures are entirely possible), it is possible not only to save energy and (cure) time but also to coat a large number of temperature-sensitive substrates which at 180° C. would exhibit unwanted yellowing, decomposition and/or embrittlement phenomena. The cure temperature includes all values and subvalues therebetween, especially including 40, 60, 80, 100, 120 and 140° C. Besides metal, glass, wood, leather, plastics, and MDF boards, certain aluminum substrates are prime candidates. In the case of the latter substrates, an excessive temperature load sometimes leads to an unwanted change in the crystal structure.

The homogenization of all of the ingredients for preparing a powder coating composition can take place in suitable equipment, such as heatable kneading apparatus, for example, but preferably by extrusion, in the course of which upper temperature limits of 120 to 130° C. ought not to be exceeded. After cooling to room temperature and appropriate comminution, the extruded mass is ground to give the ready-to-spray powder. Application of the ready-to-spray powder to appropriate substrates can be carried out in accordance with the known techniques, such as by electrostatic powder spraying, fluidized-bed sintering, or electrostatic fluid-bed sintering, for example. Following powder application, the coated workpieces are cured by heating at a temperature of from 120 to 160° C. for from 4 to 60 minutes, preferably at from 120 to 160° C. for from 6 to 30 minutes. The curing temperature includes all values and subvalues therebetween, especially including 125, 130, 135, 140, 145, 150, and 155° C. The curing time includes all values and subvalues therebetween, especially including 6, 8, 10, 12, 14, 16, 18, 20, 25, 30, 35, 40, 45, 50 and 55 minutes.

Having generally described this invention, a further understanding can be obtained by reference to certain specific examples which are provided herein for purposes of illustration only, and are not intended to be limiting unless otherwise specified.

### EXAMPLES

| Ingredients | Product description, manufacturer |
|---|---|
| VESTAGOM BF 1320 | Powder coating hardener, from Degussa AG, |
| | Coatings & Colorants, |
| | uredione content: 13.8%, m.p.: 99-112° C., T_{g}: |
| | 87° C. |
| CRYLCOAT 240 | OH-polyester, OH number: 24.5; AN: 3.3; |
| | from UCB |
| ARALDIT PT 810 | Triglycidyl ether isocyanurate (TGIC), |
| | from Vantico |
| KRONOS 2160 | Titanium dioxide, from Kronos |
| RESIFLOW PV 88 | Leveling agent, from Worlee |
| BTAC | Benzyltrimethylammonium chloride, from |
| | Aldrich |
| BH | Barium hydroxide octahydrate WC: 46, from |
| | Aldrich |
| LiPA | Lithium isopropoxide, from Aldrich |
| DBTL | Dibutyl dilaurate, from Crompton Vinyl |
| | Additives |
| | GmbH |

OH number: consumption in mg of KOH/g of polymer; AN: acid number, consumption in mg of KOH/g of polymer; m.p.: melting point; T_{g}: glass transition point; WC: water content in % by weight.

General Preparation Instructions for the Powder Coating Materials:

The comminuted ingredients: powder coating hardener, hydroxy-functional polymers, catalysts, acid scavengers, leveling agents, are intimately mixed in an edge runner mill and then homogenized in an extruder at up to 130° C. maximum. After cooling, the extrudate is fractionated and ground with a pinned-disk mill to a particle size<100 μm. The powder thus prepared is applied to degreased iron panels using an electrostatic powder spraying system at 60 kV, and the coated panels are baked in a forced air dryer.

Powder coating compositions which were obtained by the above process (amounts in % by weight, except for OHIUD):

| | VESTAGON | CRYLCOAT | | | | | |
|---|---|---|---|---|---|---|---|
| Examples | BF 1320 | 240 | BH | LiPA | BTAC | DBTL | OH/UD |
| 1 | 8.14 | 48.92 | 0.44 | | | | 1.00:0.50 |
| 2 | 11.37 | 45.52 | 0.61 | | | | 1.00:0.75 |
| 3 | 14.18 | 42.56 | 0.76 | | | | 1.00:1.00 |
| 4 | 10.43 | 46.11 | | 0.46 | 0.50 | | 1.00:0.75 |
| 5 | 13.07 | 43.35 | | 0.58 | 0.50 | | 1.00:1.00 |
| C1* | 10.43 | 46.11 | | | 0.50 | 0.46 | 1.00;0.75 |
| C2* | 13.07 | 43.35 | | | 0.50 | 0.58 | 1.00:1.00 |

*Comparative Examples

OH/UD: ratio of OH groups to uretdione groups (mol:mol)

In addition, the following were used in each of the formulations: 40.0% by weight KRONOS 2160, 1.0% by weight RESIFLOW PV 88 and 1.5% by weight ARALDIT PT 810.

Results of curing at 160° C. after 30 minutes:

| | Erichsen | Ball impact | |
|---|---|---|---|
| | cupping | direct | |
| Examples | [mm] | [inch · lb] | Remarks |
| 1 | >10.0 | 80 | Cured |
| 2 | >10.0 | 110 | Cured |
| 3 | >10.0 | >160 | Cured |
| 4 | 9.5 | 100 | Cured |
| 5 | >10.0 | 100 | Cured |
| C1* | 0.5 | 30 | not cured |
| C2* | 0.5 | 20 | not cured |

Erichsen cupping was measured according to DIN 53 156.

Ball impact was measured according to ASTM D 2794-93.

German patent application 10320267.6 filed May 3, 2004, is incorporated herein by reference.

Numerous modifications and variations on the present invention are possible in light of the above teachings. It is therefore to be understood that within the scope of the appended claims, the invention may be practiced otherwise than as specifically described herein.

What is claimed is:

1. A polyurethane powder coating composition, comprising:
A) at least one uretdione-containing powder coating hardener based on aliphatic, (cyclo)aliphatic or cycloaliphatic polyisocyanates and hydroxyl-containing compounds, having a melting point of from 40 to 130° C., a free NCO content of less than 5% by weight, and a uretdione content of 6-18% by weight,
B) at least one hydroxyl-containing polymer having a melting point of from 40 to 130° C., and an OH number of between 20 and 200 mg KOH/gram, and
C) at least one catalyst of the formula [R¹R²R³R⁴]+[R⁵]-, in which R¹-R⁴ simultaneously or independently of one another are alkyl, aryl, aralkyl, heteroaryl or alkoxyalkyl radicals, each linear or branched, unbridged or bridged with other radicals R¹-R⁴, to form cyclic, bicyclic or tricyclic systems, possible bridging atoms including not only carbon but also heteroatoms, having 1-18 carbon atoms and each radical R¹-R⁴ may further contain one or more alcohol, amino, ester, keto, thio, urethane, urea or allophanate groups, double bonds, triple bonds or halogen atoms, and R⁵ is either OH or F,
wherein
A) and B) are present in a ratio such that for each hydroxyl group of B) there is from 0.3 to 1 uretdione group of A), and
the fraction of C) is 0.001-3% by weight of the total amount of A) and B).

2. A polyurethane powder coating composition as claimed in claim 1, further comprising:
D) a reactive compound which is able to react at elevated temperatures with any acid groups that may be present in B), in an amount such that for each acid group of the resin under B) there are 0.1-10 acid-scavenging units of D).

3. A polyurethane powder coating composition as claimed in claim 1, further comprising:
E) auxiliaries and additives.

4. A polyurethane powder coating composition as claimed in claim 1, which consists essentially of A), B), and C).

5. A polyurethane powder coating composition as claimed in claim 2, which consists essentially of A), B), C), and D).

6. A polyurethane powder coating composition as claimed in claim 3, which consists essentially of A), B), C), D), and E).

7. A polyurethane powder coating composition as claimed in claim 1, containing uretdione-containing powder coating hardeners A) based on isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), and tetramethylxylylene diisocyanate (TMXDI), alone or in mixtures.

8. A polyurethane powder coating composition as claimed in claim 7, comprising uretdione-containing powder coating hardeners based on IPDI and/or HDI.

9. A polyurethane powder coating composition as claimed in claim 1, comprising uretdione-containing powder coating hardeners A) based on hydroxyl-containing polyesters, polythioethers, polyethers, polycaprolactams, polyepoxides, polyesteramides, polyurethanes, low molecular mass di-, tri- and/or tetraalcohols, monoamines and/or monoalcohols, alone or in mixtures.

10. A polyurethane powder coating composition as claimed in claim 9, comprising polyesters and/or monomeric dialcohols.

11. A polyurethane powder coating composition as claimed in claim 1, wherein B) comprises polyesters, polyethers, polyacrylates, polyurethanes, and polycarbonates, alone or in mixtures, as hydroxyl-containing polymers B).

12. A polyurethane powder coating composition as claimed in claim 1 1, comprising polyesters having an OH number of from 30 to 150 mg KOH/g, an average molecular weight of from 500 to 6000 g/mol, and a melting point of between 40 and 130° C.

13. A polyurethane powder coating composition as claimed in claim 12, comprising tetraalkylammonium hydroxide and/or tetraalkylammonium fluoride as C).

14. A polyurethane powder coating composition as claimed in claim 1, wherein C) comprises one or more members selected from the group consisting of methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethyl-phenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride.

15. A polyurethane powder coating composition as claimed in claim 2, wherein D) comprises epoxy compounds, carbodiimides and/or 2-oxazolines.

16. A polyurethane powder coating composition as claimed in claim 15, wherein D) comprises triglycidyl ether isocyanurate, EPIKOTE 828, phenylenebisoxazoline, 2-methyl-2-oxazoline, 2-hydroxyethyl-2-oxazoline, 2-hydroxypropyl-2-oxazoline, and/or 5-hydroxypentyl-2-oxazoline, alone or in mixtures.

17. A polyurethane powder coating composition as claimed in claim 3, wherein E) comprises leveling agents, light stabilizers, filler, additional catalysts and/or pigments.

18. A polyurethane powder coating composition as claimed in claim 1, which is suitable for coating metal.

19. A polyurethane powder coating composition as claimed in claim 1, which is suitable for coating wood.

20. A polyurethane powder coating composition as claimed in claim 1, which is suitable for coating leather.

21. A polyurethane powder coating composition as claimed in claim 1, which is suitable for coating plastics.

22. A process for preparing a polyurethane powder coating composition as claimed in claim 1 comprising combining A), B), and C).

23. The process according to claim 22, wherein A), B), and C) are combined at a temperature of at most 130° C.

24. The process according to claim 22, wherein A), B), and C) are combined at a temperature of at most 120° C.

25. A method of coating a substrate, comprising applying a polyurethane powder coating composition as claimed in claim 1 to the substrate.

26. A method as claimed in claim 25, wherein the substrate is heat-resistant.

27. A method as claimed in claim 25, wherein the substrate is metal, plastics, wood, glass, or leather.

28. A method as claimed in claim 25, wherein the substrate is selected from the group consisting of motorbikes, bicycles, construction components, and household appliances.

29. A method of providing a catalyst to a polyurethane powder coating composition, comprising incorporating into a polyurethane powder coating composition at least one catalyst of the formula [NR¹R²R³R⁴]+[R⁵], in which R¹-R⁴ simultaneously or independently of one another are alkyl, aryl, aralkyl, heteroaryl or alkoxyalkyl radicals, each linear or branched, unbridged or bridged with other radicals R¹-R⁴, to form cyclic, bicyclic or tricyclic systems, possible bridging atoms including not only carbon but also heteroatoms, having 1-18 carbon atoms and each radical R¹-R⁴ may further contain one or more alcohol, amino, ester, keto, thio, urethane, urea or allophanate groups, double bonds, triple bonds or halogen atoms, and R⁵ is either OH or F.

30. The method as claimed in claim 29, wherein the catalyst contains at least one member selected from the group consisting of methyltributylammonium hydroxide, methyltriethylammonium hydroxide, tetramethylammonium hydroxide, tetraethylammonium hydroxide, tetrapropylammonium hydroxide; tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride.

31. The method as claimed in claim 29, wherein the polyurethane powder coating composition contains
A) at least one uretdione-containing powder coating hardener based on aliphatic, (cyclo)aliphatic or cycloaliphatic polyisocyanates and hydroxyl-containing compounds, having a melting point of from 40 to 130° C., a free NCO content of less than 5% by weight, and a uretdione content of 6-18% by weight, and
B) at least one hydroxyl-containing polymer having a melting point of from 40 to 130° C., and an OH number of between 20 and 200 mg KOH/gram,
wherein
A) and B) are present in a ratio such that for each hydroxyl group of B) there is from 0.3 to 1 uretdione group of A), and
the fraction of C) is 0.001-3% by weight of the total amount of A) and B).

32. A method of catalyzing the curing polyurethane powder coating composition, comprising reacting a polyurethane powder coating composition which contains
A) at least one uretdione-containing powder coating hardener based on aliphatic, (cyclo)aliphatic or cycloaliphatic polyisocyanates and hydroxyl-containing compounds, having a melting point of from 40 to 130° C., a free NCO content of less than 5% by weight, and a uretdione content of 6-18% by weight, and
B) at least one hydroxyl-containing polymer having a melting point of from 40 to 130° C., and an OH number of between 20 and 200 mg KOH/gram,
in the presence of a catalytically effective amount of at least one catalyst of the formula [NR¹R²R³R⁴]+[R⁵]-, in which R¹-R⁴ simultaneously or independently of one another are alkyl, aryl, aralkyl, heteroaryl or alkoxyalkyl radicals, each linear or branched, unbridged or bridged with other radicals R¹—R⁴, to form cyclic, bicyclic or tricyclic systems, possible bridging atoms including not only carbon but also heteroatoms, having 1-18 carbon atoms and each radical R¹—R⁴ may further contain one or more alcohol, amino, ester, keto, thio, urethane, urea or allophanate groups, double bonds, triple bonds or halogen atoms, and R⁵ is either OH or F.

33. The method as claimed in claim 32, wherein the catalyst contains at least one member selected from the group consisting of methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetraoctylammonium fluoride, and benzyltrimethylammonium fluoride.
